(19) United States
(12) Patent Application Publication
(10) Pub. No.: US 2013/0183593 A1
(43) Pub. Date: Jul. 18, 2013

(54) SOLID OXIDE, SOLID OXIDE ELECTRODE, SOLID OXIDE FUEL CELL INCLUDING THE SAME, AND METHODS OF PREPARING THE SAME

(71) Applicant: Samsung Electronics Co., Ltd., Suwon-si (KR)

(72) Inventors: Hee-jung PARK, Suwon-si (KR); Tae-gon KIM, Hwaseong-si (KR); Chan KWAK, Yongin-si (KR); Doh-won JUNG, Seoul (KR); Seung-joo KIM, Gyeonggi-do (KR)

(73) Assignee: SAMSUNG ELECTRONICS CO., LTD, Suwon-si (KR)

(21) Appl. No.: 13/723,437

(22) Filed: Dec. 21, 2012

(30) Foreign Application Priority Data
Dec. 27, 2011 (KR) 10-2011-0143922

(51) Int. Cl. H01M 4/505; H01M 12/06; H01M 4/525; H01M 4/86

(52) U.S. Cl. CPC H01M 4/505; H01M 4/8621; H01M 12/06; H01M 4/525
USPC 429/405; 429/489; 423/599; 423/594.6

(57) ABSTRACT

An oxide represented by Formula 1:

A₂M₁₋ₓCₓD₂O_{7+δ} Formula 1

wherein, in Formula 1, x is in the range of 0.4≦x≦1.0; δ is selected such that the oxide electrically neutral; A is at least one metal selected from an alkaline earth metal; M is an alkaline earth metal that differs from A; C is a transition metal; and D is at least one selected from germanium (Ge) and silicon (Si).

This application claims the benefit of Korean Patent Application No. 10-2011-0143922, filed on Dec. 27, 2011, and all the benefits accruing therefrom under 35 U.S.C. §119, the content of which is incorporated herein in its entirety by reference.

### BACKGROUND

1. Field

The present disclosure relates to a solid oxide, a solid oxide electrode, a solid oxide fuel cell including the solid oxide electrode, and methods of preparing the same.

2. Description of the Related Art

Fuel cells are drawing attention as alternative energy sources and may be classified as either a polymer electrolyte membrane fuel cell (PEMFC), a phosphoric acid fuel cell (PAFC), a molten carbonate fuel cell (MCFC), or a solid oxide fuel cell (SOFC) according to the types of electrolyte used.

Solid oxide fuel cells use an ionically conductive solid oxide as an electrolyte. Solid oxide fuel cells have high efficiency and high durability, may use various kinds of fuels, and are also cost-effective.

A unit cell of a solid oxide fuel cell consists of a solid oxide electrolyte and a solid oxide electrode that form a membrane-electrode assembly (MEA). The solid oxide electrode desirably provides high electronic conductivity and high ionic conductivity. Also, solid oxide fuel cells operate at high temperature, e.g., about 400° C. to 1200° C. Because of the high temperature, the solid oxide electrode desirably provides high binding strength to a solid oxide electrolyte to accommodate its thermal expansion coefficient, which can be 10×10⁻⁶ ˜16×10⁻⁶ per Kelvin (K⁻¹), and a high melting point of 1100° C. or higher. A solid oxide electrode with improved mechanical strength and a wider range of operational temperature would be desirable. Lanthanum strontium manganite (LSM) is currently used.

An actual output voltage of the solid oxide fuel cell is lower than a theoretical value due to polarization which occurs in the solid electrolyte and in the electrode. For example, the output voltage of the solid oxide fuel cell may be represented by Equation 1:

V=V_{oc}−i(R_{electrolyte}+R_{cathode}+R_{anode})−η_{cathode}η_{anode} Equation 1

wherein V is an output voltage, V_{oc} is an open circuit voltage, i(R_{electrolyte}+R_{cathode}+R_{anode}) is a voltage from resistance polarization, and n_{cathode} and n_{anode} represent cathode and anode overpotentials, respectively, from concentration polarization, wherein i is a current, and R_{electrolyte}, R_{cathode} and R_{anode} represent the resistance of the electrolyte, the cathode, and the anode, respectively.

According to the Equation 1, the higher the electrode resistance (R_{cathode} and R_{anode}) becomes, the lower the output voltage becomes. Accordingly, to improve the output voltage of the solid oxide fuel cell, the electrode resistance of the solid oxide electrode is desirably reduced.

LSM, which has a perovskite crystal structure (ABO₃), has been used as a solid oxide electrode material. LSM has a working temperature of about 800˜1000° C., and may undergo a sharp increase in resistance when the working temperature is low. A material having a lower resistance at a low working temperature would be desirable.

### SUMMARY

Provided is an oxide, and a solid oxide electrode, which include a novel composition with mixed conductivity.

Provided is a solid oxide fuel cell including the solid oxide electrode.

Provided are methods of manufacturing the solid oxide electrode.

Additional aspects will be set forth in part in the description which follows and, in part, will be apparent from the description.

According to an aspect, disclosed is an oxide represented by Formula 1:

A₂B₁₋ₓCₓD₂O_{7+δ} Formula 1

wherein, in Formula 1,
x is in the range of 0.4≦x≦1.0; δ is selected such that the oxide electrically neutral;
A is at least one metal selected from an alkaline earth metal;
M is an alkaline earth metal that differs from A;
C is a transition metal; and
D is at least one selected from germanium (Ge) and silicon (Si).

Also disclosed is a solid oxide electrode including the oxide.

Also disclosed is an oxide including: a first alkaline earth metal; a second alkaline earth metal which is different than the first alkaline earth metal; a transition metal; and at least one selected from germanium and silicon, wherein a mole fraction of the first alkaline earth metal is about the same as a mole fraction of the at least one selected from germanium and silicon, and wherein a mole fraction of the sum of the second alkaline earth metal and the transition metal is about half of the mole fraction of the first alkaline earth metal, based on the total moles of all elements of the oxide.

Also disclosed is an oxide including: a first alkaline earth metal; a transition metal; and at least one selected from germanium and silicon, wherein a mole fraction of the first alkaline earth metal is about the same as a mole fraction of the at least one selected from germanium and silicon, and wherein a mole fraction of the transition metal is about half of the mole fraction of the first alkaline earth metal, based on the total moles of all elements of the oxide.

According to another aspect, a solid oxide fuel cell includes: a first electrode including the above-described solid oxide electrode; a second electrode; and a solid oxide electrolyte disposed between the first electrode and the second electrode.

According to another aspect, a method of manufacturing an ionically conductive oxide includes: contacting an alkaline earth metal precursor, a transition metal precursor, and a Group 14 metal precursor, and a solvent to prepare a precursor mixture; and calcining the precursor mixture to manufacture the ionically conductive oxide.

Also disclosed is a method of manufacturing a solid oxide electrode, the method including: forming a layer including the ionically conductive oxide to manufacture the solid oxide electrode.

### BRIEF DESCRIPTION OF THE DRAWINGS

These and/or other aspects will become apparent and more readily appreciated from the following description of the embodiments, taken in conjunction with the accompanying drawings in which:

FIG. 1 is a graph of intensity (arbitrary units) versus scattering angle (degrees 28) and is an X-ray diffraction spectrum of the oxide powder of Example 1;

FIG. 2 is a table of atomic site data obtained from Rietveld fitting of the X-ray diffraction spectrum of FIG. 1;

FIG. 3 is a schematic diagram of a melilite crystal structure of the oxide powder of Example 1 derived from the X-ray diffraction spectrum of FIG. 1;

FIGS. 4A and 4B are a schematic views showing interstitial oxygen sites in the melilite crystal structure;

FIG. 5 is graph of real impedance (Z₁, ohms-square centimeters (ohm-cm²)) versus imaginary impedance (Z₂, ohms-square centimeters (ohm-cm²))and is a Nyquist plot showing the results of impedance analysis on a symmetrical cell of Example 2; and

FIG. 6 is a graph of electrode resistance (log Rₚ (ohms-square centimeters, Ohm-cm²)) versus temperature (1/T, 1/Kelvin (K)) obtained in Evaluation Example 2.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Rather, these embodiments are provided so that this disclosure will be thorough and complete, and will fully convey the scope of the invention to those skilled in the art. Like reference numerals refer to like elements throughout. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. As used herein, the term “and/or” includes any and all combinations of one or more of the associated listed items. Expressions such as “at least one of,” when preceding a list of elements, modify the entire list of elements and do not modify the individual elements of the list. “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“Transition metal” means an element of Groups 3 to 11 of the Periodic Table of the Elements.

Hereinafter, an embodiment of a solid oxide, a solid oxide electrode including the solid oxide, a solid oxide fuel cell including the solid oxide electrode, and a method of manufacturing the foregoing will be described in greater detail.

According to an embodiment, there is provided an oxide represented by Formula 1:

A₂M₁₋ₓCₓD₂O_{7+δ} Formula 1

wherein, in Formula 1, x is in the range of 0.4≦x≦1.0; δ is selected such that the oxide electrically neutral; A is at least one metal selected from alkaline earth metals; M is an alkaline earth metal that differs from A; C is a transition metal; and D is at least one selected from germanium (Ge) and silicon (Si).

The oxide includes a transition metal. While not wanting to be bound by theory, it is understood that overlap of the transition metal orbitals within a crystal structure of the oxide facilitates migration of electrons within the oxide, so that the oxide may have high electronic conductivity. The electronic conductivity of the oxide may be at least about 1 Siemens per centimeter (Scm⁻¹), specifically about 10 to about 1000 Scm⁻¹, more specifically about 100 to about 800 Scm⁻¹.

The oxide may also have high ionic conductivity. For example, the oxide may also have high oxygen ion conductivity. In an embodiment, the oxide of Formula 1 is a mixed conductor having substantial ionic conductivity and electronic conductivity. The mixed conductivity of the oxide may reduce the resistance of the solid oxide electrode including the oxide. The ionic conductivity of the oxide of Formula 1 may be at least about 0.01 siemen per centimeter (Scm⁻¹), specifically about 0.01 to about 200 Scm⁻¹, more specifically about 0.1 to about 100 Scm⁻¹.

The oxide may have a crystal structure of the P 4̅2₁ m space group. For example, the oxide may have a melilite crystal structure. In an embodiment, the oxide has a tetragonal crystal structure.

In an embodiment, and while not wanting to be bound by theory, the oxide may have ionic conductivity derived from interstitial oxygen disposed therein. In an embodiment, in the oxide of Formula 1 above, δ corresponds to a content of interstitial oxygen. For example, δ may be in the range of 0<δ≦0.5, and in an embodiment, may be in the range of 0.1<δ≦0.5, and in another embodiment, δ may be about ½x.

In the oxide of Formula 1 above, A may be at least one selected from Sr and Ba; M may be at least one selected from Mg and Ca, and C may be at least one selected from a metal of Groups 6 to 9, specifically Groups 7 to 8 of the Periodic Table of the Elements. In an embodiment, C may be at least one selected from Mn, Fe, Co, and Cr, and in an embodiment C may be divalent and/or trivalent. In the oxide of Formula 1 above, D may be at least one selected from Si and Ge.

The oxide may include an oxide represented by Formula 2 below:

A₂M₁₋ₓCₓGe₂O_{7+δ} Formula 2

In Formula 2 above, x is in the range of 0.4≦x≦1.0; δ is in the range of 0<δ≦0.3; A is at least one selected from Sr and Ba; M is at least one selected from Mg and Ca; and C is at least one selected from Mn, Fe, and Co.

The oxide of Formula 2 may be at least one selected from Sr₂Mg_{0.2}Mn_{0.8}Ge₂O_{7+δ}, Sr₂MnGe₂O_{7+δ}, Sr₂Mg_{0.2}Co_{0.8}Ge₂O_{7+δ}, Sr₂CoGe₂O_{7+δ}, Sr₂Mg_{0.2}Fe_{0.8}Ge₂O_{7+δ}, and Sr₂FeGe₂O_{7+δ}.

The solid oxide electrode may have an electrode resistance of about 0.32 ohm-cm² or less at about 850° C. For example, the solid oxide electrode may have an electrode resistance of about 0.30 ohm-cm² or less at 850° C. For example, the solid oxide electrode may have an electrode resistance of about 0.28 ohm-cm² or less at 850° C.

The oxide with high mixed conductivity, i.e., both ionic conductivity and electronic conductivity as described above, may be suitable for application in a wide range of industrial fields, including in a solid oxide electrode.

In an embodiment disclosed is an oxide comprising: a first alkaline earth metal; a second alkaline earth metal which is different than the first alkaline earth metal; a transition metal; at least one selected from germanium and silicon; and oxygen, wherein a mole fraction of the first alkaline earth metal is about the same as the mole fraction of the at least one selected from germanium and silicon, and wherein a mole fraction of a sum of the second alkaline earth metal and the transition metal is about half of the mole fraction of the first alkaline earth metal, based on a total moles of all elements of the oxide.

In another embodiment disclosed is oxide comprising: a first alkaline earth metal; a transition metal; at least one selected from germanium and silicon; and oxygen, wherein a mole fraction of the first alkaline earth metal is about the same as the mole fraction of the at least one selected from germanium and silicon, and wherein a mole fraction of the transition metal is about half of the mole fraction of the first alkaline earth metal, based on a total moles of all elements of the oxide.

The first alkaline earth metal is an alkaline earth metal, specifically at least one selected from Sr and Ba.

The second alkaline earth metal is an alkaline earth metal different than the first alkaline earth metal, specifically at least one selected from Mg and Ca.

In an embodiment, the transition metal is at least one selected from Mn, Fe, Co, and Cr.

In an embodiment, the second alkaline earth metal and the transition metal are present in a mole ratio of about 0.01 to about 1.5, specifically about 0.1 to about 1.

Also disclosed is a solid oxide electrode comprising the oxide. The solid oxide electrode may have any suitable shape, and may have a shape selected from spherical, rectilinear, curvilinear, rectangular, and square. The solid oxide electrode may be in the form of a film, e.g., a film disposed on a substrate. The solid oxide electrode may have any suitable thickness, and may have a thickness of about 10 nanometers (nm) to about 100 micrometers (μm), and in an embodiment, a thickness of about 100 nm to about 50 μm.

The electronic conductivity of the solid oxide electrode may be at least about 1 Siemens per centimeter (Scm⁻¹), specifically about 10 to about 1000 Scm⁻¹, more specifically about 100 to about 800 Scm⁻¹. The ionic conductivity of the solid oxide electrode may be at least about 0.01 siemen per centimeter (Scm⁻¹), specifically about 0.01 to about 200 Scm⁻¹, more specifically about 0.1 to about 100 Scm⁻¹. Also, the solid oxide electrode may have an electrode resistance of about 0.32 ohms per square centimeter or less at 850° C., specifically about 0.01 to about 0.3 ohms per square centimeter at 850° C.

According to another aspect, there is provided a solid oxide fuel cell including a first electrode comprising the above-described oxide, a second electrode, and a solid oxide electrolyte disposed between the first electrode and the second electrode. The solid oxide fuel cell may comprise a stack of unit cells.

For example, the first electrode of the solid oxide fuel cell may be an air electrode (i.e., a cathode). In an embodiment, the solid oxide fuel cell may include the solid oxide electrode as an air electrode (i.e., cathode); a fuel electrode (i.e., anode); and a solid oxide electrolyte disposed between the air electrode and the fuel electrode. The solid oxide fuel cell may comprise a stack of unit cells. For example, the stack of unit cells may include a serial stack of membrane-electrode assemblies (MEAs) each including the air electrode, the fuel electrode, and the solid oxide electrolyte, and a separator disposed between adjacent MEAs to electrically connect the same.

A material for forming the air electrode may be the oxide represented by Formula 1:

A₂M₁₋ₓCₓD₂O_{7+δ} Formula 1

wherein, in Formula 1, x is in the range of 0.4≦x≦1.0; δ is selected such that the oxide electrically neutral; A is at least one metal selected from alkaline earth metal; M is an alkaline earth metal that differs from A; C is a transition metal; and D is at least one selected from germanium (Ge) and silicon (Si).

In addition to the oxide of Formula 1 above, a suitable solid oxides that is known in the art may be further included. Examples of such solid oxides include particulate metal oxides with a perovskite crystal structure, and particulate metal oxides, such as at least one selected from (Sm,Sr)CoO₃, (La,Sr)MnO₃, (La,Sr)CoO₃, (La,Sr)(Fe,Co)O₃, (La,Sr)(Fe,Co,Ni)O₃, and the like. These particulate metal oxides may be used alone or in combination with at least two thereof. The air electrode may further comprise a noble metal, such as at least one selected from platinum (Pt), ruthenium (Ru), rhodium, palladium (Pd), silver, osmium, iridium, gold, and the like. In an embodiment, the air electrode may comprise at least one selected from La_{0.8}Sr_{0.2}Mn0₃ (LSM), La_{0.6}Sr_{0.4}Co_{0.8}Fe_{0.2}O₃ (LSCF), and the like.

The solid oxide electrolyte may be any suitable electrolyte material. For example, the solid oxide electrolyte may include a particulate composite metal oxide including at least one selected from zirconium oxide, cerium oxide, and lanthanum oxide. Examples of the particulate composite metal oxide include at least one selected from yttria-stabilized zirconia (YSZ), scandia-stabilized zirconia (SsSZ), samaria-doped ceria (SDC), and gadolinia-doped ceria (GDC). The solid oxide electrolyte may have a thickness of about 10 nanometers (nm) to about 100 micrometers (pm), and in an embodiment, a thickness of about 100 nm to about 50 μm.

The fuel electrode may comprise a cermet, e.g., a mixture of the material forming the solid oxide electrolyte and a nickel oxide. The fuel electrode may further include activated carbon.

According to another embodiment, a method of preparing the above-described ionically conductive oxide includes contacting an alkaline earth metal precursor, a transition metal precursor, and a Group 14 metal precursor with a solvent to prepare a precursor mixture; and calcining the precursor mixture in an air atmosphere to obtain an ionically conductive oxide.

According to another embodiment, a method of preparing the above-described solid oxide electrode includes contacting an alkaline earth metal precursor, a transition metal precursor, and a Group 14 metal precursor with a solvent to prepare a precursor mixture; and calcining the precursor mixture in an air atmosphere to obtain a solid oxide electrode.

The solvent may be any suitable solvent that is used in the art. The solvent may be, for example, water, ethanol, or the like. Examples of suitable solvents include at least one selected from an alcohol (e.g., methanol, ethanol, butanol); water; liquid carbon dioxide; an aldehyde (e.g., an acetaldehyde, propionaldehyde), formamide (e.g., N, N-dimethylformamide); a ketone (e.g., acetone, methyl ethyl ketone, p-bromoethyl isopropyl ketone); acetonitrile; a sulfoxide (e.g., dimethylsulfoxide, diphenylsulfoxide, ethyl phenyl sulfoxide); a sulfone (e.g., diethyl sulfone, phenyl 7-quinolylsulfone); a thiophene (e.g., thiophene 1-oxide); an acetate (e.g., ethylene glycol diacetate, n-hexyl acetate, 2-ethylhexyl acetate); and an amide (e.g., propanamide, benzamide).

The mixing of the precursors with the solvent may be performed using any suitable methods that is known in the art, for example, mechanical milling, mechanical stirring, or ultrasonic stirring, but is not limited thereto.

The method of preparing the oxide, and/or the solid oxide electrode, may further include drying the mixture to remove the solvent before the calcining of the mixture. The calcining may be conducted in any suitable atmosphere. In an embodiment, the calcining is conducted in an oxygen containing atmosphere, specifically in air.

In an embodiment of the preparation method, the calcining may be performed at a temperature of about 1000° C. to about 1500° C., specifically about 1050° C. to about 1450° C., more specifically about 1100° C. to 1400° C. However, the calcining temperature is not limited thereto, and may be appropriately selected.

In an embodiment of the preparation method, the calcining may be performed for about 1 hour to about 10 hours, specifically about 2 hours to about 8 hours. However, the calcining time is not limited thereto, and may be appropriately selected.

In an embodiment of the preparation method, the alkaline earth metal precursor may include a single alkaline earth metal, and in another embodiment includes a plurality of alkaline earth metals.

In an embodiment of the preparation method, the alkaline earth metal precursor may be a precursor of at least one metal selected from Sr, Ba, Mg, and Ca. The transition metal precursor may be at least one metal precursor selected from the metals of Groups 6 to 9, specifically Groups 7 to 8, of the Periodic Table of the Elements. The Group 14 metal precursor may be a precursor of at least one metal selected from Si and Ge.

For example, a precursor of alkaline earth metal, e.g., alkaline earth metal A and alkaline earth metal M if present, a precursor of the transition metal, e.g., transition metal C, and a precursor of the Group 14 metal may be mixed in ethanol to prepare a mixed precursor solution. The mixed precursor solution may be mixed using a ball mill to prepare a mixed slurry, which may then be dried at a temperature of about 100° C. or less to obtain dried powder. Afterward, the dried powder may be calcined at about 1200° C., specifically about 800° C. to about 1400° C., in the air for about 3 hours, specifically about 0.5 to about 6 hours, to obtain an ionically conductive oxide, which may be in the form of a powder.

The ionically conductive oxide powder may be additionally thermally treated and/or pressed to form an electrode having a selected shape. The shape may be any suitable shape, and may be rectilinear, curvilinear, or spherical, as desired.

Hereinafter, an embodiment will be described in further detail with reference to the following examples. However, these examples shall not limit the scope of the disclosed embodiment.

### (Preparation of Oxide Powder)

### Preparation Example: Preparation of Sr₂Mg_{0.2}Mn_{0.8}Ge₂O_{7+δ}

5.8606 grams (g) of SrCO₃ powder, 0.1600 g of MgO powder, 1.8253 g of MnCO₃ powder, and 4.1540 g of GeO₂ powder were put in a plastic vessel together with zirconia balls (3 mole percent yttria stabilized zirconia, 3YSZ) and 20 mL of ethanol, and then ball-milled for about 12 hours to obtain a mixed slurry, which was then heated on a hot plate at about 80° C. to obtain dried powder. The dried powder was calcined in air at about 1,200° C. for about 3 hours to obtain oxide powder with a melilite structure. The resulting compound was Sr₂Mg_{0.2}Mn_{0.8}Ge₂O_{7+δ} powder.

### Preparation Example 2: Preparation of Sr₂MnGe₂O_{7+δ}

5.7184 g of SrCO₃ powder, 2.2266 g of MnCO₃ powder, and 4.0539 g of GeO₂ powder were put in a plastic vessel together with zirconia balls (3YSZ) and 20 mL of ethanol, and then ball-milled for about 12 hours to obtain a mixed slurry, which was then heated on a hot plate at about 80° C. to obtain dried powder. The dried powder was calcined in air at about 1,200° C. for about 3 hours to obtain oxide powder with a melilite structure. The resulting compound was Sr₂MnGe₂O_{7+δ} powder.

### Preparation Example 3: Preparation of Sr₂Mg_{0.6}Mn_{0.4}Ge₂O_{7+δ}

6.1652 g of SrCO₃ powder, 0.5049 g of MgO powder, 0.9600 g of MnCO₃ powder, and 3698 g GeO₂ powder were put in a plastic vessel together with zirconia balls (3YSZ), and 20 mL of ethanol, and then ball-milled for about 12 hours to obtain a mixed slurry, which was then heated on a hot plate at about 80° C. to obtain dried powder. The dried powder was calcined in air at about 1,200° C. for about 3 hours to obtain oxide powder with a melilite structure. The resulting compound was Sr_{2M}g_{0.6M}n_{0.4G}e_{2O7+δ} powder.

### Preparation Example 4: Preparation of Sr₂Mg_{0.2}Co_{0.8}Ge₂O_{7+δ}

6.1425 g of SrCO₃ powder, 0.1676 g of MgO powder, 1.3358 g of Co₃O₄ powder, and 4.3538 g of GeO₂ powder were put in a plastic vessel together with zirconia balls (3YSZ) and 20 mL of ethanol, and then ball-milled for about 12 hours to obtain a mixed slurry, which was then heated on a hot plate at about 80° C. to obtain dried powder. The dried powder was calcined in air at about 1,000° C. for about 3 hours to obtain oxide powder with a melilite structure. The resulting compound was Sr₂Mg_{0.2}Co_{0.8}Ge₂O_{7+δ} powder.

### Preparation Example 5: Preparation of Sr₂CoGe₂O_{7+δ}

6.0586 g of SrCO₃ powder, 1.6470 g of Co₃O₄ powder, and 4.2943 g of GeO₂ powder were put in a plastic vessel together with zirconia balls (3YSZ) and 20 ml of ethanol, and then ball-milled for about 12 hours to obtain a mixed slurry, which was then heated on a hot plate at about 80° C. to obtain dried powder. The dried powder was calcined in the air at about 1,000° C. for about 3 hours to obtain oxide powder with a melilite structure. The resulting compound was Sr₂CoGe₂O_{7+δ} powder.

### (Manufacture of Electrode and Symmetrical Cell)

### EXAMPLE 1

### (Preparation of Electrolyte)

An electrolyte was prepared using commercially available GDC (Ce_{0.9}Gd_{0.1}O₂) powder. The GDC powder was pressed using a metal mold as a cell support, and then calcined at about 1500° C. for about 8 hours.

### (Manufacture of Electrode)

The oxide powder from Preparation Example 1 was mixed with commercially available ink vehicle (FCM, Fuel Cell Materials Co.) using a mortar to prepare a slurry, which was coated on opposite ends of the electrolyte via screen printing, and heat treated at about 1200° C. for about 3 hours to be fixed on the electrolyte, thereby manufacturing electrodes on the opposite ends of the electrolyte.

### (Manufacture of Current Collector)

A current collection layer for collecting electricity generated from the cell was formed by brushing Ag slurry (H4580, available from Shoei Chemical Inc.) on a surface of the electrode and then heat treating the coated Ag slurry at about 700° C. for 1 hour, hereby manufacturing a symmetrical cell.

### EXAMPLES 2 to 5

Electrodes and symmetrical cells were manufactured in the same manner as in Examples 2 to 5, except that the oxide powders from Preparation Examples 2 to 5 were respectively used.

### (X-ray Diffraction Analysis)

### Evaluation Example 1

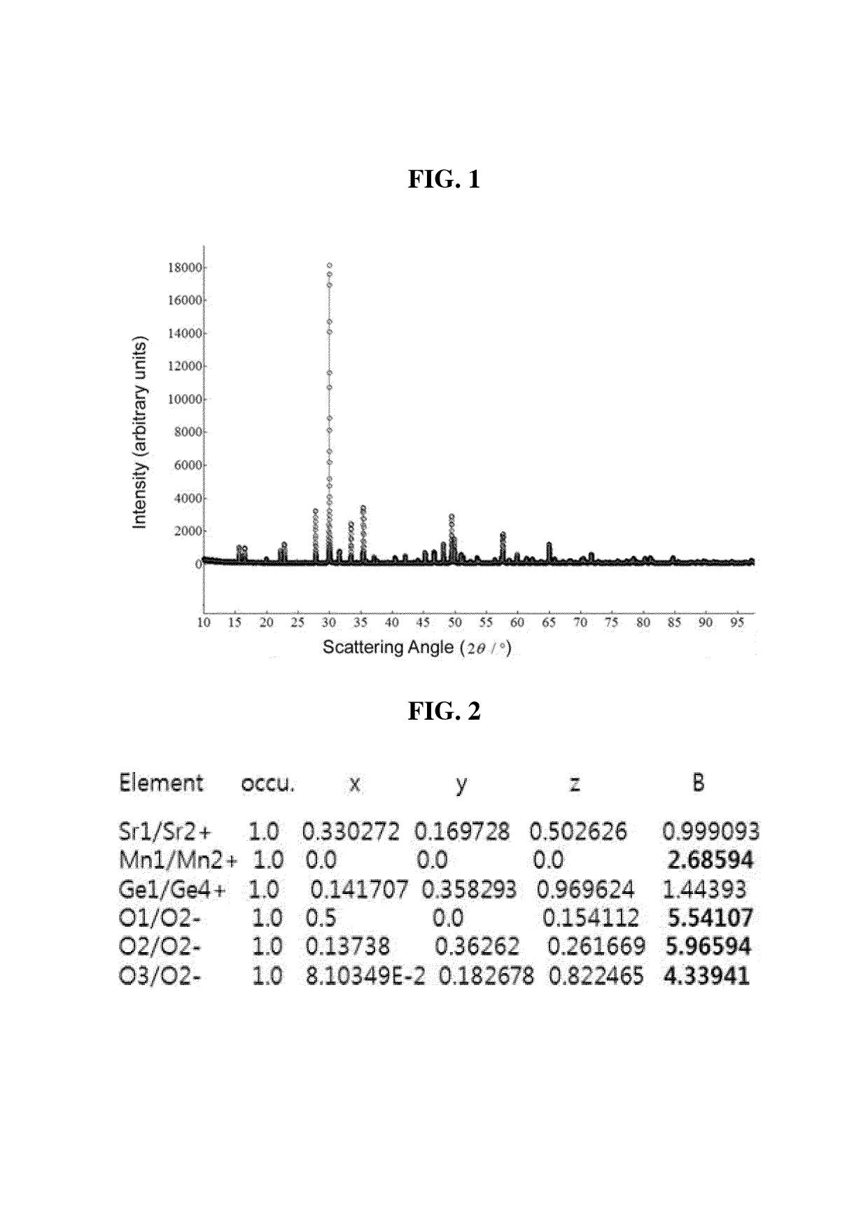

The calcined powders of Preparation Examples 1 to 5 were analyzed by X-ray diffraction. Some of the results are shown in FIG. 1. FIG. 1 is an X-ray diffraction (XRD) spectrum from the oxide powder of Preparation Example 2.

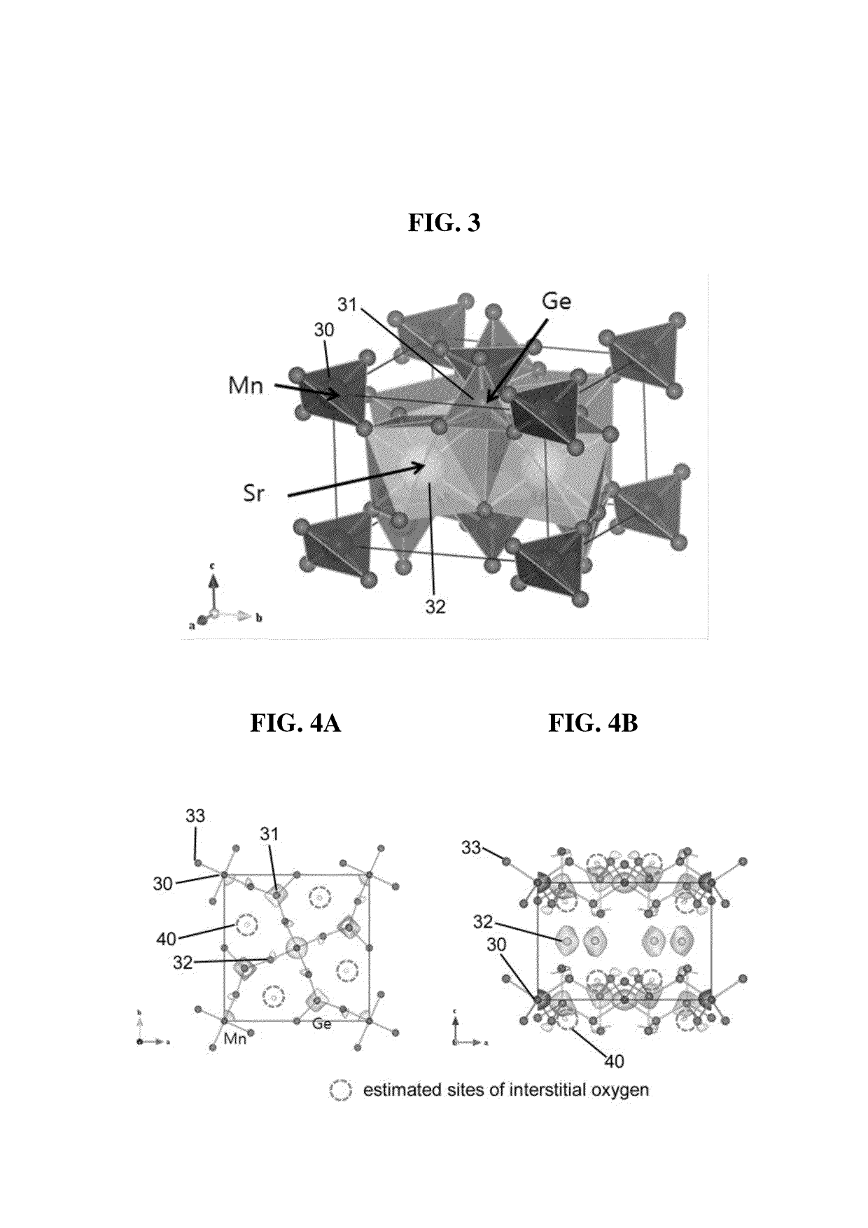

The oxide from Preparation Example 2 having the melilite crystal structure was identified through a Rietveld fitting of the XRD spectrum of FIG. 1 Atomic sites derived from the Rietveld fitting are shown in FIG. 2. FIG. 3 is a schematic view of the melilite crystal structure obtained based on the atomic sites of FIG. 2. Shown in FIG. 3 are Mn atoms 30, Ge atoms 31, Sr atoms 32 and O atoms 33 of the structure.

Unlike common melilite crystal structures, the results of the Rietveld fitting of FIG. 2, which show that the degrees of broadening, as indicated by the parameter B in FIG. 2, is greater than 1, indicate that the oxide from Preparation Example 2 includes additional oxygen atoms in the crystal structure, which is not present in common melilite crystal structures. While not wanting to be bound by theory, it is understood that the additional oxygen atom is interstitial oxygen positioned between Mn and Ge.

An electronic structure of the oxide was derived through a Fourier transform of the XRD data using the maximum entropy method. As a result, the presence of the interstitial oxygen ions was identified. FIGS. 4A and 4B illustrate estimated interstitial oxygen sites 40 in the melilite crystal structure.

While not wanting to be bound by theory, the presence of the interstitial oxygen is understood to provide the ionic conductivity of the oxide. In addition, the presence of the transition metal in the oxide is understood to provide the electronic conductivity of the oxide.

### (Measurement of Positive Electrode Resistance)

### Evaluation Example 2

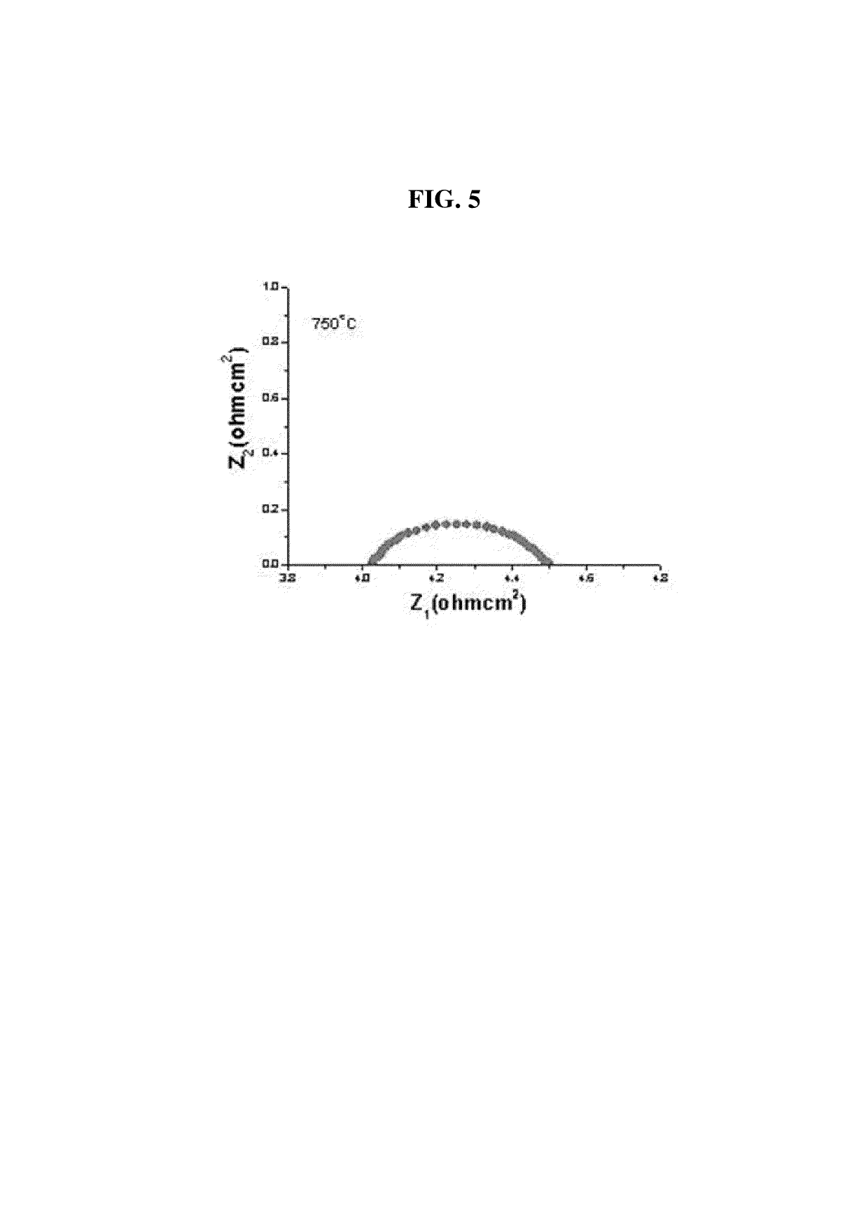

Electrode polarization resistance was measured on the symmetrical cells of Examples 1 to 5 using an impedance analyzer (Material Mates 7260 impedance analyzer) according to a 2-probe method. The frequency range was from about 0.1 Hertz (Hz) to about 10 MHz. The measurement was performed in an oxygen atmosphere in a range of varying temperatures of from about 600° C. to about 800° C. FIG. 5 is a Nyquist plot of the impedance measurement data on the symmetrical cell of Example 2. In FIG. 5, a resistance difference between the two points of a half circle intersecting the X-axis corresponds to an electrode resistance.

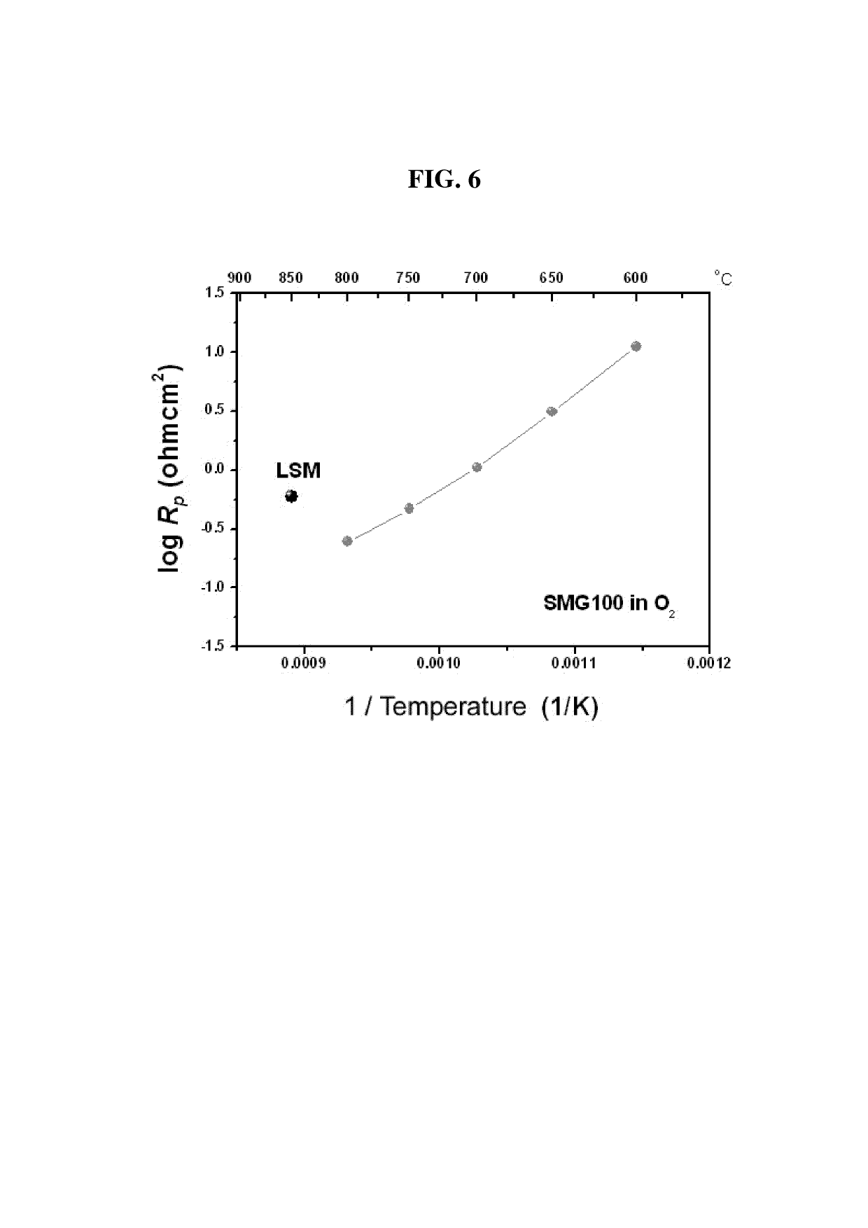

FIG. 6 is a graph of electrode resistance with respect to temperature obtained from the impedance measurement results. In FIG. 6, LSM indicates a resistance of lanthanum strontium manganite (LSM), as disclosed in X. J. Chen, K. A. Khor, and S. H. Chan, Solid State Ionics, 2004, 379-387.

Referring to FIG. 6, the electrode of the symmetrical cell of Example 2 is found to have a similar resistance as LSM, which is one of the most widely used SOFC electrodes, at a significantly lower temperature.

That is, the oxide may have a remarkably lower resistance as compared with LSM at the same temperature.

As described above, according to an embodiment, an oxide, and a solid oxide electrode, with mixed conductivity may have reduced resistance. A solid oxide fuel cell including the solid oxide electrode may have an improved driving voltage and a lower driving temperature.

It shall be understood that the exemplary embodiment described herein shall be considered in a descriptive sense only and not for purposes of limitation. Descriptions of features, advantages, or aspects within each embodiment shall be considered as available for other similar features, advantages, or aspects in other embodiments.

What is claimed is:

1. An oxide represented by Formula 1:
A₂M₁₋ₓCₓD₂O_{7+δ} Formula 1
wherein, in Formula 1,
x is in the range of 0.4≦x≦1.0;
δ is selected such that the oxide of Formula 1 is electrically neutral;
A is at least one metal selected from an alkaline earth metal;
M is an alkaline earth metal that differs from A;
C is a transition metal; and
D is at least one selected from germanium (Ge) and silicon (Si).

2. The oxide of claim 1, wherein the oxide has an electronic conductivity.

3. The oxide of claim 1, wherein the oxide has an ionic conductivity.

4. The oxide of claim 1, wherein the oxide has a crystal structure having a P 4̅2₁ m space group.

5. The oxide of claim 1, wherein the oxide has a crystal structure having a melilite structure.

6. The oxide of claim 1, wherein the oxide includes an interstitial oxygen.

7. The oxide of claim 2, wherein A in Formula 1 is at least one selected from Sr and Ba.

8. The oxide of claim 1, wherein M in Formula 1 is at least one selected from Mg and Ca.

9. The oxide of claim 1, wherein C in Formula 1 is at least one element selected from Group 7 to Group 8 of the Periodic Table of the Elements.

10. The oxide of claim 1, wherein C is at least one selected from Mn, Fe, Co, and Cr.

11. The oxide of claim 1, wherein D is at least one selected from Si and Ge.

12. The oxide of claim 1, wherein the oxide is represented by Formula 2:
A₂M₁₋ₓCₓGe₂O_{7+δ} Formula 2
wherein, in Formula 2,
x is in the range of 0.4≦x≦1.0;
δ is selected such that the oxide is electrically neutral;
A is at least one selected from Sr and Ba;
M is at least one selected from Mg and Ca; and
C is at least one selected from Mn, Fe, and Co.

13. The oxide of claim 1, wherein the oxide is at least one selected from Sr₂Mg_{0.2}Mn_{0.8}Ge₂O_{7+δ}, Sr₂MnGe₂O_{7+δ}, Sr₂Mg_{0.2}Co_{0.8}Ge₂O_{7+δ}, Sr₂CoGe₂O_{7+δ}, Sr₂Mg_{0.2}Fe_{0.8}Ge₂O_{7+δ}, and Sr₂FeGe₂O_{7+δ}.

14. A solid oxide electrode comprising the oxide of claim 1.

15. The solid oxide electrode of claim 14, wherein the solid oxide electrode has an electrode resistance of about 0.32 ohms per square centimeter or less at 850° C.

16. A solid oxide fuel cell comprising:
a first electrode comprising the solid oxide electrode of claim 14;
a second electrode; and
a solid oxide electrolyte disposed between the first electrode and the second electrode.

17. The solid oxide fuel cell of claim 16, wherein the first electrode is an air electrode.

18. An oxide comprising:
a first alkaline earth metal;
a second alkaline earth metal which is different than the first alkaline earth metal;
a transition metal;
at least one selected from germanium and silicon; and
oxygen,
wherein a mole fraction of the first alkaline earth metal is about the same as a mole fraction of the at least one selected from germanium and silicon, and
wherein a mole fraction of a sum of the second alkaline earth metal and the transition metal is about half of the mole fraction of the first alkaline earth metal,
based on a total moles of all elements of the oxide.

19. A method of manufacturing an ionically conductive oxide, the method comprising:
contacting an alkaline earth metal precursor, a transition metal precursor, and a Group 14 metal precursor, and a solvent to prepare a precursor mixture; and
calcining the precursor mixture to manufacture the ionically conductive oxide.

20. The method of claim 19, further comprising drying the mixture before the calcining.

21. The method of claim 19, wherein the calcining is performed at a temperature of from about 1000° C. to about 1500° C. for about 1 to 10 hours.

22. The method of claim 19, wherein the alkaline earth metal precursor comprises at least one alkaline earth metal.
